(19) United States
(12) Patent Application Publication
(10) Pub. No.: US 2006/0085751 A1
(43) Pub. Date: Apr. 20, 2006

(54) Music user interface

(76) Inventors: John P.F. O'Brien, Vancouver (CA); Donald C. MacKinnon, Seattle, WA (US); Lisa A. Laarman, Seattle, WA (US); Robert F. Dixon JR., Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/214,215

(22) Filed: Aug. 29, 2005

Related U.S. Application Data
(60) Provisional application No. 60/619,492, filed on Oct. 14, 2004.

(51) Int. Cl. G06F 3/00; G06F 17/00; G06F 9/00

(52) U.S. Cl. 715/727

(57) ABSTRACT

A music user interface presents various thematic choices, such as themes organized around various artists, to organize digital music so as to enhance the user's browsing, playing, and purchasing experience. An “Artist Choice” user interface presents a dual presentation of a selected artist and his/her music preferences. A “Now Playing” user interface presents music selections being performed inside a store. A “Burn” user interface allows the rapid production of a music CD containing the choices of the listener/browser.

### CROSS-REFERENCE TO RELATED APPLICATION

This application claims the benefit of U.S. Provisional Patent Application No. 60/619,492, filed Oct. 14, 2004, which is incorporated herein by reference.

### FIELD OF THE INVENTION

The present invention relates generally to user interfaces, and more particularly, to user interfaces for enhancing the experience of browsing, playing and purchasing digital music.

### BACKGROUND OF THE INVENTION

Many digital audio coding schemes exist that allow recorded music to be easily distributed over any modern medium, such as the Internet. These digital audio coding schemes cause the size of audio information to be compressed greatly without significantly degrading the quality of the reproduced sound. As a result, digital music formed from these digital audio coding schemes has proliferated. Software manufacturers have crafted software that allows users to manage lists of digital music, to play sound files containing digital music, and to allow users to purchase digital music. FIG. 1A illustrates one such piece of software 102 for controlling, playing, and purchasing digital music.

The software 102 includes a navigational bar 104, which is a horizontal space at the top of a window presenting various user interface elements for the software 102. One such user interface element includes a rewind element 106, which is visually represented as a circle enclosing two isosceles triangles with their apices pointing leftward. The rewind element 106 allows a user to reverse the progression of a piece of digital music being played. A play element 108 is selectable by the user to play a piece of digital music and is visually represented as a circle enclosing an isosceles triangle with its apex pointing rightward. To fast-forward a piece of digital music being played, a fast-forward element 110 can be selected and is visually represented as yet another circle enclosing two, isosceles triangles where their apices point rightward. Within the proximity of elements 106-110 is a window 112 for displaying information such as the song being played, the time remaining in connection with the song being played, the status of the downloading of a particular piece of digital music, and so on. Adjacently located to the right of the window 112 is yet another window 114 for allowing the user to search for information in the software 102. A magnifying glass symbol is shown in connection with the window 114 signifying to the user that the window 114 is to be used for searching purposes.

Because the lists of digital music managed by the software 102 can be extensive, a source element 116 allows various organizational schemes of the digital music to be formed and managed by the software 102. A “library” element 118 denotes a complete list of pieces of digital music managed by the software 102. A “party shuffle” element 120 allows a generation of arbitrary pieces of digital music based on the information in the “library” element 118. Selection of a “radio” element 122 brings the user to a stream presentation of music and other audio information from various radio stations broadcasting on the Internet. A “music store” element 124, upon selection, causes the user to enter into a music store for browsing and purchasing pieces of digital music. Those pieces of digital music created or performed in the 1990s are accessible by selecting a “90s music” element 126.

A user interface panel 130 collectively displays a number of album elements, such as an album element 132, which upon selection brings the user to a list of songs available with that particular album. A number of album elements, such as the album element 132, appear when the user selects the “music store” element 124. A navigational element 134 allows the user to browse additional albums not displayed by the user interface panel 130 and appears as a circle enclosing a leftward pointing arrow.

A “celebrity playlist” element 128 textually displays names of various celebrities, such as Minnie Passer; Ozomatic; Elvis Pho; TobyMacIntosh; Rufus Wrong; Bruce Tails; Inxsexy; Eric Luna; Kelly Smith; Sammy Mo; and Jadasoc. The “celebrity playlist” element 128 allows the user to access songs that are favored by a particular celebrity by selecting on the particular celebrity name, which acts as a link to another user interface. For example, by selecting Minnie Passer, the user is brought to another user interface screen shown in FIG. 1B.

Many elements in FIG. 1B are similar to those previously discussed in connection with FIG. 1A and they shall not be further discussed for brevity purposes. An image 138 represents Minnie Passer, but any suitable representations can be used. Located within the immediate proximity of the image 138 is a textual element 136 (“Minnie's Playlist”) and a quotation from Minnie Passer. The playlist of Minnie is shown as a matrix of three columns. The first column 140 contains song names, such as “Tear-Stained Eye” and “Jesus,” etc. The second column 142 contains names of various artists, such as “Son Volt” and “Wilco,” and the third column 144 contains names of various albums, such as “Trace” and “Yankee . . . . ”

One of the problems is that the user is forced to navigate away from the celebrity playlists so as to see the playlist of a particular celebrity. Deeply nested user interfaces detract rather than enhance the browsing experience of users. Thus, there is a need for better systems, methods, and computer-readable media for browsing, playing, and purchasing digital music while avoiding and reducing the foregoing and other problems associated with existing systems.

### SUMMARY OF THE INVENTION

In accordance with this invention, a system, method, and computer-readable medium for enhancing the browsing, playing, or purchasing of digital music is provided. The system form of the invention comprises—in a computer system including a display—a user input facility, and an application for presenting user interfaces on the display, a set of thematic user interface elements presented on the display. Each thematic user interface element represents a collection of digital music that corresponds to a theme. The system further comprises a set of album user interface elements presented contemporaneously with the set of thematic user interface elements on the display. The set of album user interface elements represents a portion of the collection of digital music corresponding to a thematic user interface element.

In accordance with a further aspect of the invention, another system form of the invention comprises—in a computer system including a display—a user input facility, and an application for presenting user interfaces on the display, a song user interface element presented on the display. The song user interface element represents a song currently being played. The system further comprises a set of played song user interface elements presented contemporaneously with the song user interface elements on the display. The set of played song user interface elements represents songs that were recently played.

In accordance with a further aspect of the invention, another system form of the invention comprises—in a computer system including a display—a user input facility, and an application for presenting user interfaces on the display, a set of song user interface elements presented on the display. The set of song user interface elements represents songs under consideration by a user for purchasing. The system further comprises a burn user interface element presented on the display. The burn user interface element is clickable once to indicate the purchase of the songs under consideration and to cause the burning of the songs under consideration to a computer-readable medium.

In accordance with a further aspect of this invention, a method form of the invention comprises receiving a selection of a thematic user interface element from a set of thematic user interface elements presented on the display. Each thematic user interface element represents a collection of digital music that corresponds to a theme. The method further comprises displaying a set of album user interface elements that is presented contemporaneously with the set of thematic user interface elements on the display. The set of album user interface elements represents a portion of the collection of digital music corresponding to the selected thematic user interface element.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1A-1B are pictorial diagrams illustrating two user interface screens of a conventional software for browsing, playing, and purchasing digital music;

FIG. 2A is a pictorial diagram illustrating an exemplary user interface for browsing digital music organized according to various themes, such as an artist's theme;

FIG. 2B is a pictorial diagram illustrating a user interface for browsing, playing, and purchasing digital music organized under a particular theme;

FIG. 2C is a pictorial diagram illustrating an exemplary user interface for presenting pieces of digital music that are currently being played and pieces of digital music that were recently played for a user to browse, play, and purchase;

FIG. 3 is a pictorial diagram illustrating an exemplary user interface for browsing, playing, and purchasing digital music;

FIGS. 4A-4G are process diagrams illustrating an exemplary method formed in accordance with this invention for processing requests for browsing and purchasing digital music.

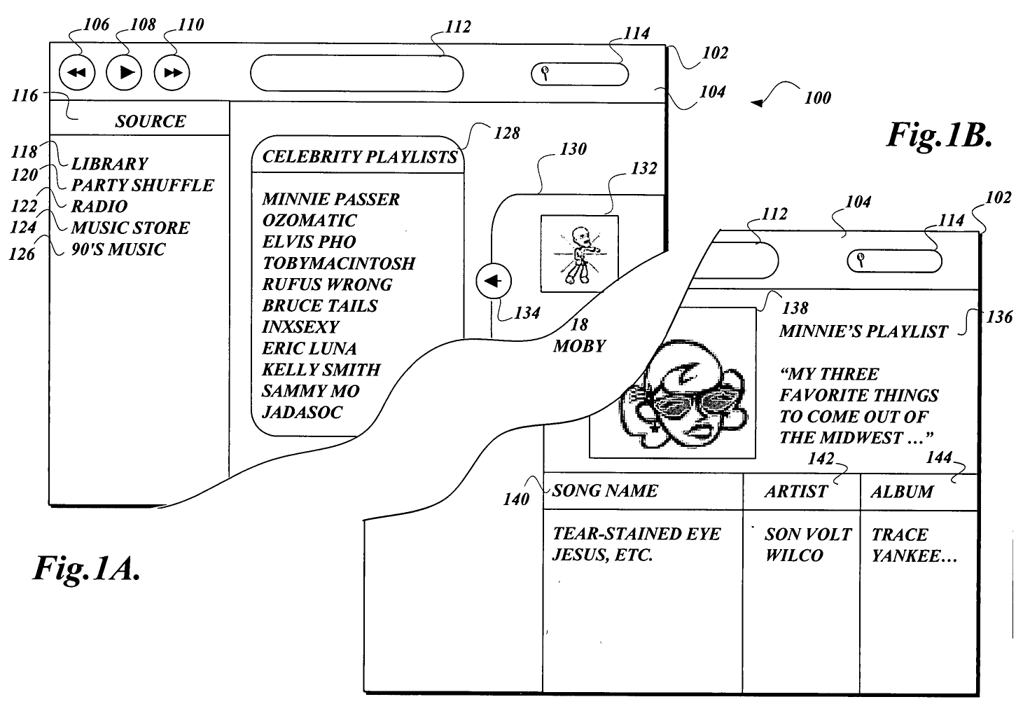

### DETAILED DESCRIPTION OF THE PREFERRED EMBODIMENT

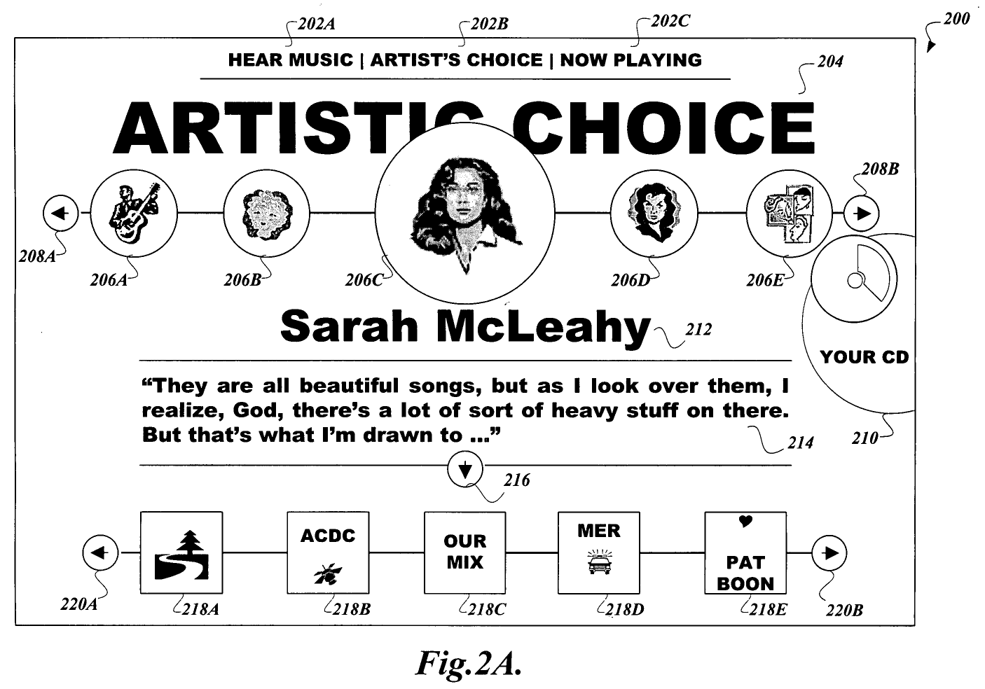

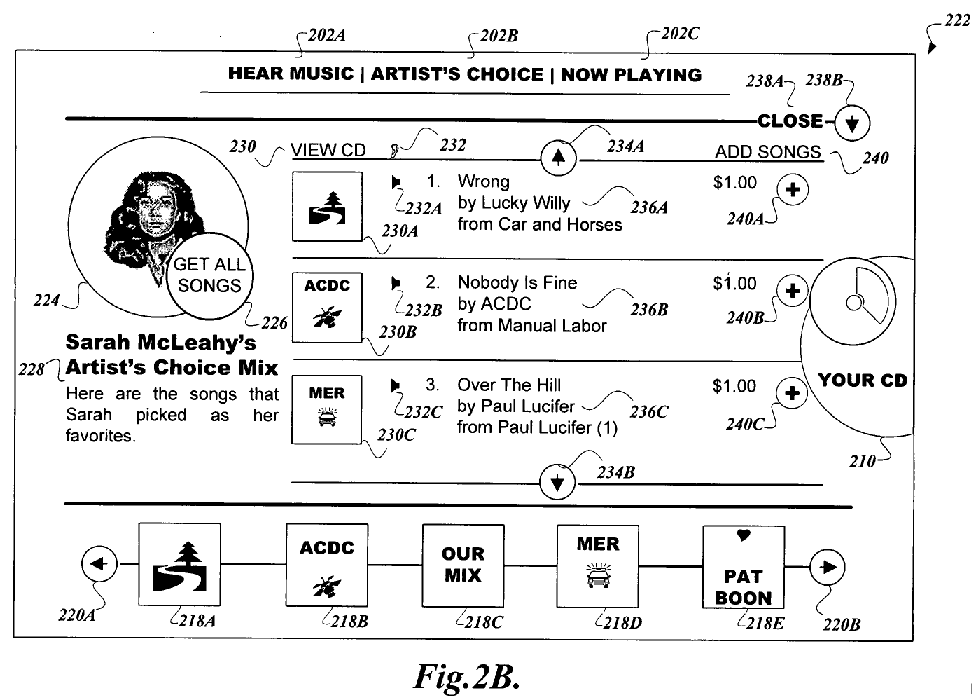

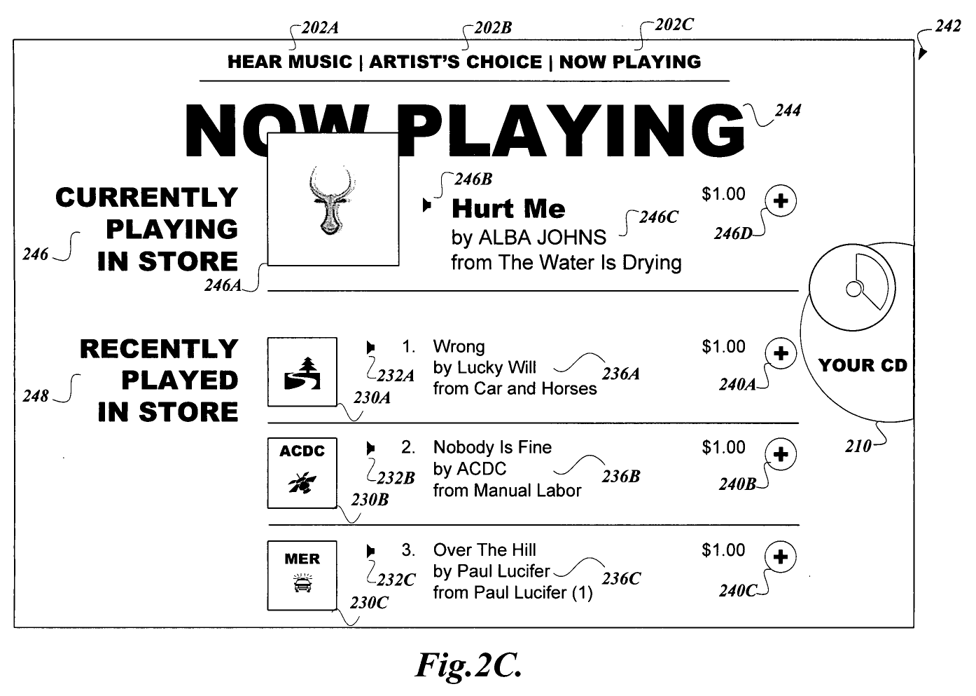

FIG. 2A illustrates an exemplary user interface screen 200 produced by a collection of user interface elements that work together to allow a user to browse, play, and purchase digital music. More specifically, the user interface screen 200 includes a number of menu selections, such as menu 202a (“Hear Music”); another menu 202b (“Artist's Choice”); and as yet another menu 202c (“Now Playing”). Upon selection, the menu 202a “Hear Music” opens another user interface screen (not shown) for allowing the user to browse through songs that are available for the user to play or to purchase.

The user interface screen 200 is presented when the user clicks on the menu 202b “Artist's Choice,” which presents various thematic choices, and in this particular case are themes organized around various artists. It should be appreciated that the invention is not limited to themes organized around artists, but instead any suitable themes can be created to organize digital music so as to enhance the user's browsing, playing, and purchasing experience. Subjacently located with respect to a collection of menus 202a-202c is a title element 204 presenting “Artistic Choice” in large, bold letters, which acts as a visual indication of the selected menu choice by the user. Located within the immediate lower proximity of the textual element 204 is a collection of choice elements 206a-206e framed by navigational buttons 208a, 208b. Each choice element 206a-206e is a member of the organized theme, and in this particular case, each choice element 206a-206e represents an artist (hereinafter “artist elements 206a-206e”).

Each artist element is visually represented as a circle enclosing an image to visually depict the artist. One of the artist elements selected as a focus will be magnified, such as the artist element 206c, which is also centered to indicate its selection by the user. The artist elements 206a-206e are framed by a previous element 208a and a next element 208b. The previous element 208a appears as a circle enclosing a leftward pointing arrow, which indicates that upon clicking, additional artist elements are made available. Similarly, the previous element 208b also appears as a circle enclosing a rightward pointing arrow, and upon selection shows additional artist elements. Located below the focus artist element 206c is a name element 212 textually displaying the name of the artist (“Sarah McLeahy”) represented by the focus artist element 206c. A quote from the artist Sarah McLeahy is shown just below the name element 212 and is referenced by a quote element 214: “They are all beautiful songs, but when I look over them, I realize, God, there's a lot of sort of heavy stuff on there. But that's what I'm drawn to . . . . ” The quote element 214 is framed by two horizontal lines and additional quote text can be accessed by clicking on a down element 216, which appears as a circle enclosing a downward pointing arrow. To the left of the user interface screen 200 is a menu 210 “your CD,” which is visually displayed as a half circle overlapped with a graphic-styled CD-ROM. The details in connection with the selection of the menu 210 “Your CD” are discussed hereinbelow.

When the artist element 206c is selected and becomes the focus element, music that is organized to support a particular theme represented by the focus element is shown at the bottom of the user interface screen 200, such as album elements 218a-218e. In this instance; albums 218a-218e are albums that contain songs preferred by Sarah McLeahy, who is the focus artist element 206c. Album elements 218a-218e are framed by a previous element 220a and a next element 220b. The previous element 220a appears as a circle enclosing a leftward pointing arrow and the next element 220b appears as a circle enclosing a rightward pointing arrow. When selected, elements 220a, 220b scroll and make available additional album elements connected with the focus artist element 206c.

Album elements 218a, 218b, 218d, and 218e appear as a miniaturized version of the album art on actual physical albums. Album element 218c is a collection of songs selected from various albums preferred by Sarah McLeahy, such as album elements 218a, 218b, 218d, and 218e. Suppose that when the user clicks upon the album element 218c “Our Mix,” the user is brought or to a user interface screen 222 is presented. See FIG. 2B. A number of elements shown in FIG. 2B are similar to those discussed previously in connection with FIG. 2A and for brevity purposes will not be further discussed.

The user interface screen 222 displays a list of songs organized under the album element 218c “Our Mix.” A close element 238a, upon selection by the user, will collapse the list of songs so as to reveal the previously displayed user interface screen, such as the user interface screen 200. Similar in functionality, a down element 238b appears as a circle enclosing a downward pointing arrow that will collapse or close the list of songs and reveals the previously displayed user interface screen. An image 224 enclosed in a circle is identical to the image displayed in connection with the focus artist element 206c Sarah McLeahy. All the songs preferred by Sarah McLeahy can be placed under consideration for further browsing, playing, or purchasing by clicking on a button 226, “Get All Songs.” A textual element 228, “Sarah McLeahy's Artist Choice Mix: Here are the songs that Sarah picked as her favorites,” is subadjacently located in connection with the image 224 so as to allow the user to know that the songs displayed rightward are those songs that are preferred by Sarah McLeahy. These songs appear as a matrix of five columns framed by two horizontal lines and an up element 234a and a down element 234b. The up element 234a appears as a circle enclosing an upward pointing arrow and the down element 234b appears as a circle enclosing a downward pointing arrow, both allowing the user to access additional songs. The first column is described by a textual element 230 “View CD.” Column 230 contains a number of pieces of miniaturized artwork from the album covers. For example, a graphic element 230a corresponds to the album element 218a; a graphic element 230b corresponds to the album element 218b; and a graphic element 230c corresponds to the album element 218d. The second column 232 contains numerous buttons 232a-232c in the form of mini loudspeakers, which can be selected by the user to play a particular song. The third column contains song names, artist names, and album names. Textual elements 236a-236c provide pieces of information connected with the songs, artists, and the albums. For example, textual element 236a describes “1. Wrong by Lucky Willy from Car and Horses”; textual element 236b describes “2. Nobody is Fine by ACDC from Manual Labor”; and textual element 236c “3. Over The Hill by Paul Lucifer from Paul Lucifer (1)”. The fourth column contains the price of each song (e.g., “$1.00”) but its presentation is entirely optional. The fifth column is described by the textual element 240, “Add Songs,” and contains a number of buttons 240a-240c that appear as a circle enclosing a large “+” sign. These buttons 240a-240c allow the user to indicate songs of interest for later consideration for further browsing, playing, or purchasing.

Upon selecting the menu 202c, “Now Playing,” a user interface screen 242 appears as shown in FIG. 2C. A title element 244, “Now Playing,” is presented using large, bold letters to distinguish it from other textual elements on the page and to indicate the selection of the user interface screen 242, “Now Playing.” A section element 246, “Currently Playing in Store,” textually signifies that song information within its immediate proximity is a song being heard by the user over loudspeakers or headphones. An image 246a is taken from the cover of the album or the CD and is situated over a portion of the title element 244. A speaker icon 246b can be selected by the player to replay the song. A textual element 246c displays the song being played, “Hurt Me,” the artist “Alba Johns” and the name of the album “The Water Is Drying.” The price of the song for purchasing, “$1.00,” is displayed, but it is entirely optional to display the price of the song. A button 246d appears as a circle enclosed by a large “+” sign, which when selected adds the song “Hurt Me” to a list of songs for consideration by the user to further browse, play, or purchase. Below the song shown as currently being played is a list of songs previously played. A section element 248 “Recently Played in Store” marks the beginning of the lists of songs previously played. Various elements connected with the list of songs previously played are similar to those elements discussed in connection with FIG. 2B and they shall not be further discussed for brevity purposes.

A user interface screen 248 is presented to the user when the button 210, “Your CD Is Selected,” is pressed. A graphic element 250a of a CD-ROM appears to the left of the user interface screen 248. Underneath the graphic element 250a is a title element 250b, “Your CD,” for indicating the name of the user interface screen presented to the user. Underneath the title element 250b announcing the title of the user interface screen 248 is textual element 250b which textually discloses the number of tracks and the pricing for those tracks: “9 tracks for $10.99.” Additionally, the textual element 250b discloses the number of minutes remaining available for the user to play additional songs on the CD-ROM: “42:34 minutes remaining.”

A matrix of three columns describes various songs under consideration by the user for purchasing. These songs are framed by up, down elements 268a, 268b. The up element 268a appears as a circle enclosing an upward pointing arrow and the down element 268b appears as a circle enclosing a downward pointing arrow. These up, down elements 268a, 268b cause additional songs to be shown to the user when they are selected. A column 252 visually marked by an ear icon indicates that a number of speaker icons 254a-266a play songs when they are selected. For example, when the speaker icon 254a is selected, the song “Wrong” by “Lucky Will,” represented by the textual element 254b, will play for the user. The second column textually displays names of songs and artists 254b-266b, such as “Nobody Is Fine by ACDC”; “Over the Hill by Paul Lucifer”; “Goodness by Doggie James”; “Failure by New 29”; “Wave of Joy by the Elves”; and “White Coffee by Marie Works.” Textual element 270, “Remove Songs,” indicates that the third column contains numerous buttons 254c-266c, each appearing as a circle enclosing a large “−” sign. When one of the buttons 254c-266c is selected, a corresponding song is removed from the list of consideration by the user for further browsing, playing, or purchasing.

A close button 272 collapses the user interface screen 248 to reveal a previously displayed user interface screen, such as user interface screens 200, 222, and 242. A reorder button 274, when selected, allows the user to reorder the songs shown and is framed by the up, down elements 268a, 268b. A clear button 276 removes all songs under consideration by the user so as to allow the user to start afresh. A burn button 278 allows a one-click operation permitting all songs under consideration by the user to be purchased and immediately burned onto a computer-readable medium, such as a CD-ROM or a DVD.

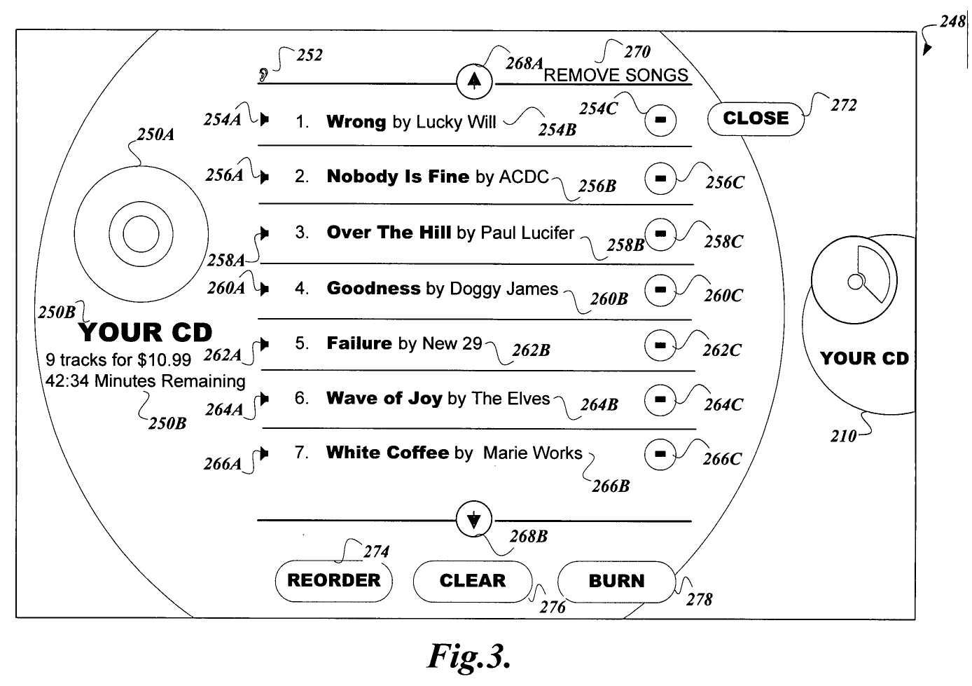

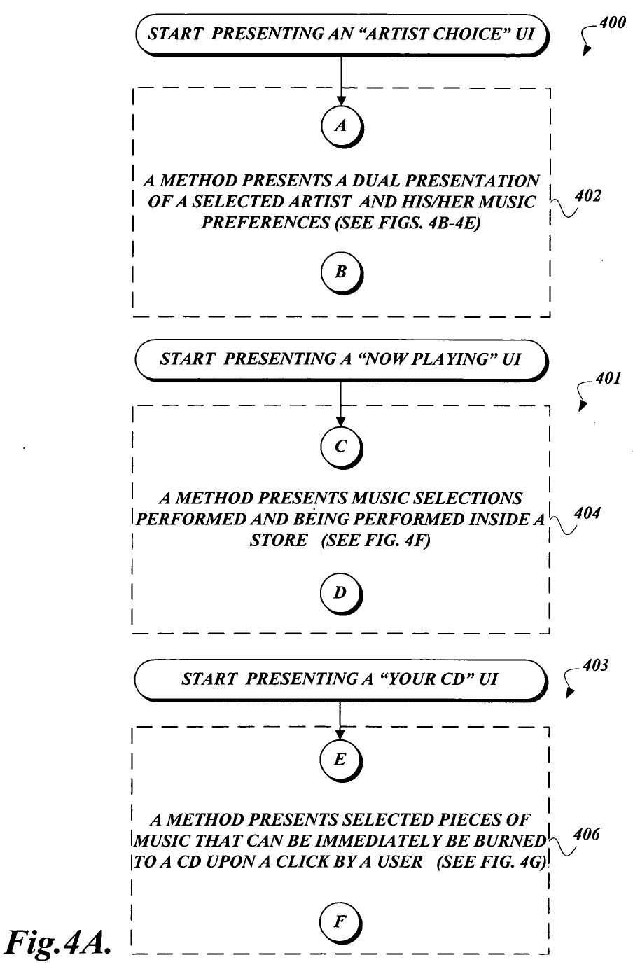

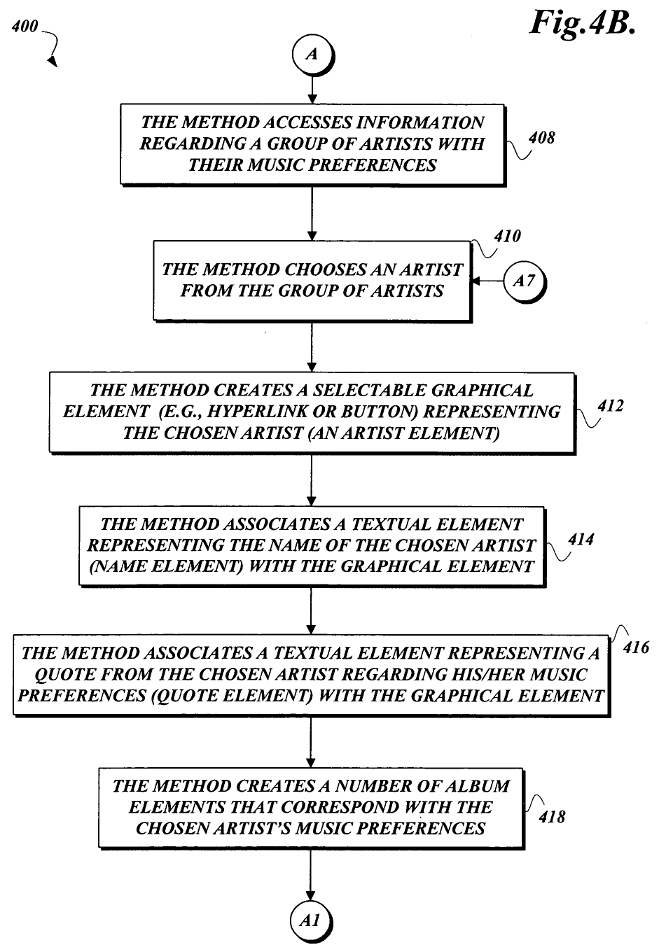

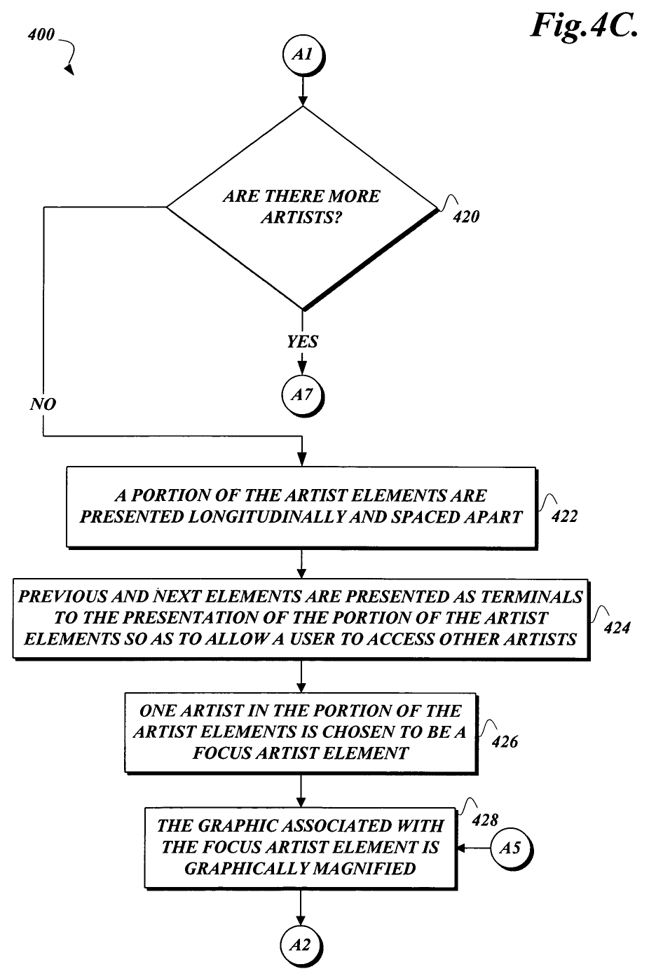

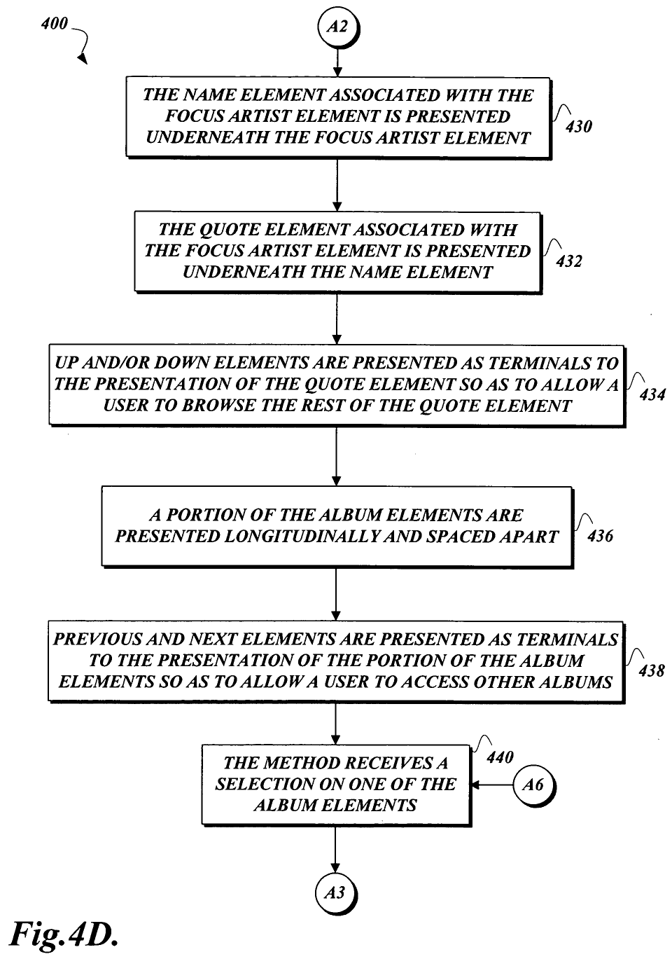

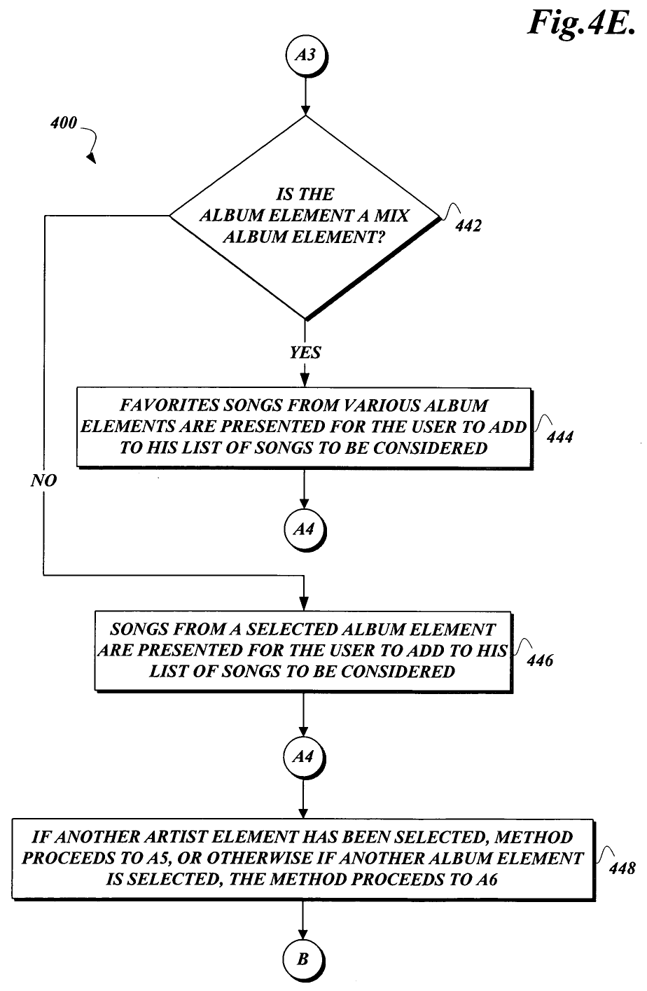

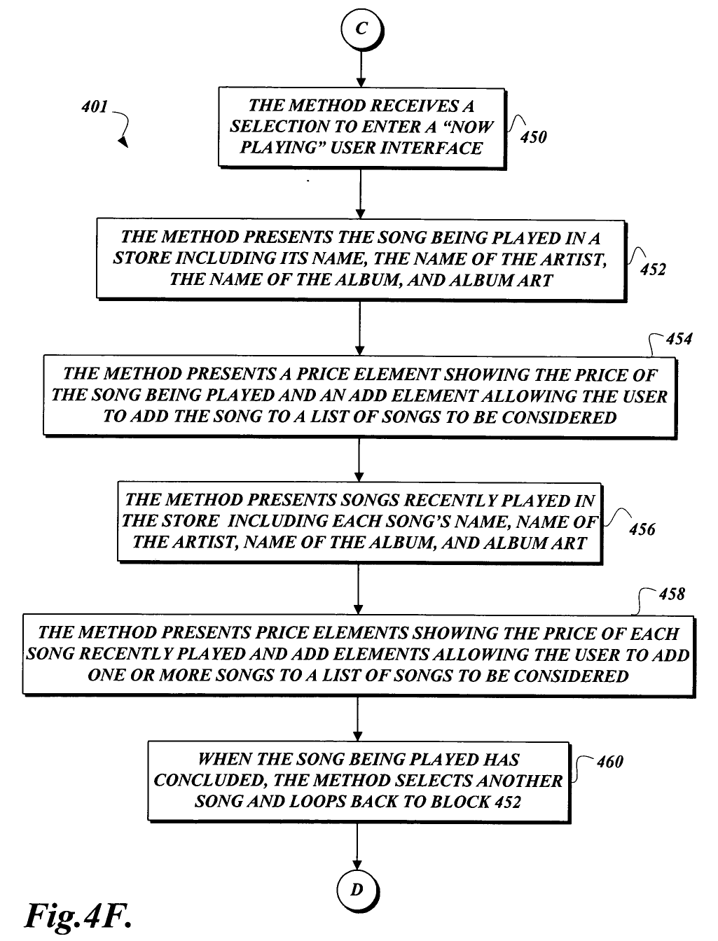

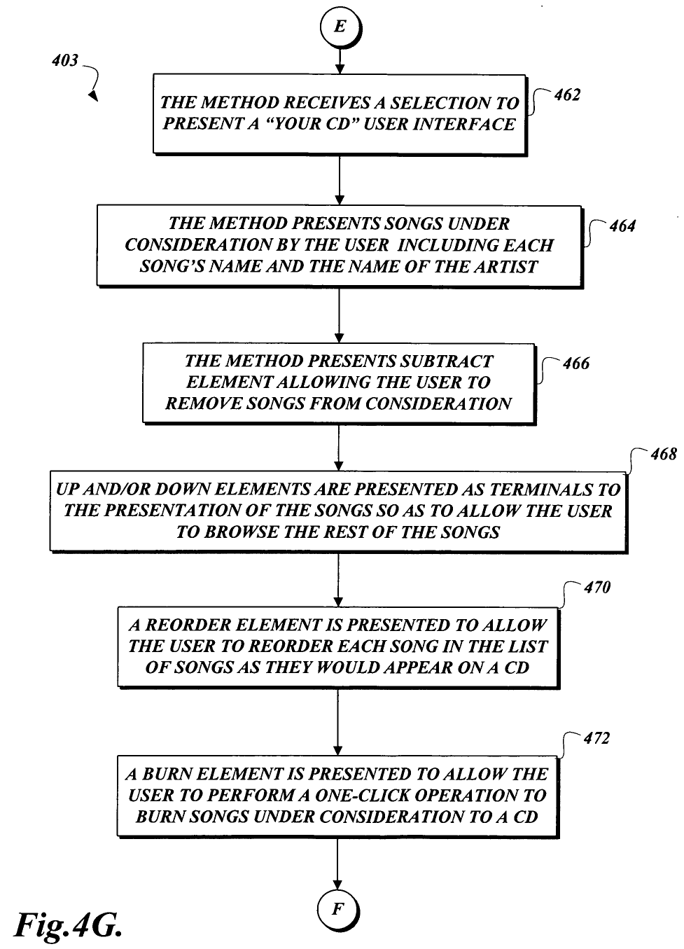

FIGS. 4A-4G illustrate processes 400, 401, and 403 for processing selections made by the user to browse, play, or purchase digital music. For clarity purposes, the following description of processes 400, 401, and 403 make references to various elements illustrated in connection with the user interface screen 200 (FIG. 2A); the user interface screen 222 (FIG. 2B); the user interface screen 242 (FIG. 2C); and the user interface screen 248 (FIG. 3). From a start block, the process 400 proceeds to a set of method steps 402 between a continuation terminal (“Termiinal A”) and an exit terminal (“Terminal B”). The method steps 402 present a dual presentation of a selected artist and his/her music preferences.

From Terminal A (FIG. 4B), the method 400 proceeds to block 408 where the method accesses information regarding a thematic collection, such as a group of artists with their music preferences. Note that various embodiments of the present invention are not limited to the use of artists and their preferences but can include any suitable theme and the collection of digital music connected with that particular theme. The method chooses an artist from the group of artists. See block 410. Next, at block 412, the method creates a selectable graphical element (e.g., hyperlink or button) representing the chosen artist. See the artist elements 206a-206e. The method 400 then proceeds to block 414 where it associates a textual element, such as the name element 212, “Sarah McLeahy,” with the graphical element representing the chosen artist. The method also associates a textual element representing a quote by the artist, such as the quote element 214 regarding her music preferences, with the graphical element. See block 416. Next, at block 418, the method creates a number of album elements 218a-218e that correspond with the chosen artist's music preferences. The method 400 then continues at another continuation terminal (“Terminal A1”).

From Terminal A1 (FIG. 4C), the method 400 proceeds to decision block 420 where a test is performed to determine whether there are more artists. If the answer to the test at decision block 420 is YES, the method 400 continues to another continuation terminal (“Terminal A7”) and loops back to block 410 where the above-identified processing steps are repeated. If the answer to the test at decision block 420 is NO, the method 400 proceeds to block 422 where a portion of the artist elements are presented longitudinally and spaced apart. See FIG. 2A where artist elements 206a-206e are illustrated. Previous and next elements, such as elements 208a-208b, are presented as terminals to frame the presentation of the portion of the artist elements 206a-206e so as to allow a user to access other artists not shown. See block 424. Next, at block 426, one artist, such as the artist element 206c, Sarah McLeahy, is chosen to be a focus artist element. The method 400 then proceeds to block 428 where the graphic associated with the focus artist element 206e is magnified. The method 400 then continues at another continuation terminal (“Terminal A2”).

From Terminal A2 (FIG. 4D), the method 400 proceeds to block 430 where the name element associated with the focus artist element is presented underneath the focus artist element. See FIG. 2A where the name element 212 appears beneath the focus artist element 206c. The quote element 214 associated with the focus artist element 206c is presented underneath the name element 212. See block 432. At block 434, up and/or down elements, such as the down element 216, are presented as terminals to the presentation of the quote element 214 so as to allow a user to browse the rest of the quote element. The method 400 then proceeds to block 436 where a portion of the album elements 218a-218e are presented longitudinally and spaced apart. The previous and next elements 220a, 220b are presented as terminals to frame the presentation of the portion of the album elements 218a-218e so as to allow the user to access other albums. See block 438. At block 440, the method receives a selection of one of the album elements, such as the album element 218c. The method 400 then continues to another continuation terminal (“Terminal A3”).

From Terminal A3 (FIG. 4E), the method 400 proceeds to decision block 442 where a test is performed to determine whether the album element is a mixed album element. If the answer to the test at decision block 442 is YES, favorite songs from various album elements 218a-218e are presented for the user to add to his list of songs to be considered. See block 444 and see also FIG. 2B. The method 400 then proceeds to another continuation terminal (“Terminal A4”). If the answer to the test at decision block 442 is NO, the method 400 proceeds to block 446 where songs from a selected album element are presented for the user to add to his list of songs to be considered. The method then continues to Terminal A4 (FIG. 4E). At block 448, if another artist element has been selected, the method proceeds to another continuation terminal (“Terminal A5”) where the method loops back to block 428 and the above-identified processing steps are repeated. Otherwise, if another album element is selected, the method proceeds to another continuation terminal (“Terminal A6”) where the method loops back to block 440 and the above-identified processing steps are repeated. The method 400 then continues to the exit Terminal B.

From a start block, the method 401 proceeds to a set of method steps 404 defined between a continuation terminal (“Terminal C”) and an exit terminal (“Terminal D”). The set of method steps 404 presents music selections performed and being performed inside a store. From Terminal C (FIG. 4F), the method 401 proceeds to block 450 where the method receives a selection to enter a “Now Playing” user interface screen 242. At block 452, the method presents the song being played in a store including its name, the name of the artist, the name of the album, and album art. At block 454, the method presents a price element (optional) showing the price of the song being played and an add element allowing the user to add the song to a list of songs to be considered. The method 401 proceeds to block 456 where the method presents songs recently played in the store, including each song's name, name of the artist, name of the album, and album art. The method 401 presents price elements (optional) showing the price of each song recently played and add elements allowing the user to add one or more songs to a list of songs to be considered. See block 458. At block 460, when the song being played has concluded, the method selects another song and loops back to block 452 where the above-identified processing steps are repeated.

From a start block, the method 403 proceeds to a set of method steps 406 defined between a continuation terminal (“Terminal E”) and an exit terminal (“Terminal F”). The set of method steps 406 presents selected pieces of music that can be immediately burned to a computer-readable medium, such as a CD-ROM, upon a click by a user. From Terminal E (FIG. 4G), the method 403 proceeds to block 462 where the method receives a selection to present a “Your CD” user interface screen 248. The method 403 presents songs under consideration by the user including each song's name and the name of the artist. See block 464. At block 466, the method 403 presents a subtract element allowing the user to remove songs from consideration. The method 403 then proceeds to block 468 where the up and/or down elements are presented as terminals to the presentation of a song so as to allow the user to browse the rest of the songs. A reorder element is presented to allow the user to reorder each song in the list of songs as they would appear on a CD. See block 470. At block 472, a burn element is presented to allow the user to perform a one-click operation to burn songs under consideration to a CD-ROM.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer system including a display, a user input facility, and an application for presenting user interfaces on the display, comprising:
a set of thematic user interface elements presented on the display, each thematic user interface element representing a collection of digital music that corresponds to a theme; and
a set of album user interface elements presented contemporaneously with the set of thematic user interface elements on the display, the set of album user interface elements representing a portion of the collection of digital music corresponding to a thematic user interface element.

2. The computer system of claim 1, wherein the theme includes artists and their musical preferences.

3. The computer system of claim 1, wherein each thematic user interface element appears as a circle enclosing an image depicting the theme, each thematic user interface located longitudinally and spaced apart.

4. The computer system of claim 1, wherein the set of thematic user interface elements includes a focus thematic user interface element, the focus thematic user interface element being presented with a first textual element that describes the name of the theme and a second textual element that provides additional text describing the theme.

5. The computer system of claim 1, wherein each album user interface element appears as a miniaturized image depicting the original album artwork, each album user interface element located longitudinally and spaced apart.

6. A computer system including a display, a user input facility, and an application for presenting user interfaces on the display, comprising:
a song user interface element presented on the display, the song user interface element representing a song currently being played; and
a set of played song user interface elements presented contemporaneously with the song user interface elements on the display, the set of played song user interface elements representing songs that were recently played.

7. The computer system of claim 6, wherein the song user interface element includes an album user interface element that appears as a miniaturized image depicting the original album artwork and further includes a textual element that discloses the name of the song, the name of the artist, and the name of the album.

8. The computer system of claim 6, wherein the set of played song user interface elements is presented as a matrix, a first column of the matrix containing miniaturize images depicting original album artwork for the set of played song user interface elements, a second column of the matrix containing textual elements describing song names, artist names, and album names.

9. The computer system of claim 6, further including a price element that textually presents the price of a song.

10. The computer system of claim 6, further including an add element for allowing a song to be added to a list of songs under consideration by a user.

11. A computer system including a display, a user input facility, and an application for presenting user interfaces on the display, comprising:
a set of song user interface elements presented on the display, the set of song user interface elements representing songs under consideration by a user for purchasing; and
a burn user interface element presented on the display, the burn user interface element being clickable once to indicate the purchase of the songs under consideration and to cause the burning of the songs under consideration to a computer-readable medium.

12. The computer system of claim 11, further including a minus user interface element that is selectable to remove a particular song from the songs under consideration by the user.

13. The computer system of claim 11, further including a reorder user interface element that is selectable to allow the order to be changed of the songs under consideration by the user.

14. The computer system of claim 11, further including a clear user interface element that is selectable to get rid of all songs under consideration by the user so as to start afresh.

15. The computer system of claim 11, further including a user interface element that is selectable to play a song under consideration.

16. A computer-implemented method comprising:
receiving a selection of a thematic user interface element from a set of thematic user interface elements presented on the display, each thematic user interface element representing a collection of digital music that corresponds to a theme; and
displaying a set of album user interface elements that is presented contemporaneously with the set of thematic user interface elements on the display, the set of album user interface elements representing a portion of the collection of digital music and corresponding to the selected thematic user interface element.

17. The method of claim 16, further comprising, in response to a selection made upon an album user interface element, displaying a set of songs connected with the selected album user interface elements, the act of displaying the set of songs including displaying an add element so as to allow a user to add a song from the set of songs to a list of songs under consideration.

18. The method of claim 16, further comprising, in response to a selection made to display songs being played and that were recently played, displaying a song being played and a list of songs that were recently played, the act of displaying the song including displaying miniaturize album artwork, song names, artist names, and album names.

19. The method of claim 16, further comprising displaying an add element to allow a song being played or songs that were recently played to be added to a list of songs under consideration by the user.

20. The method of claim 16, further comprising displaying a burn user interface element that when selected causes the list of songs under consideration to be purchased and burned to a computer-readable medium.
